(19) United States
(12) Patent Application Publication
(10) Pub. No.: US 2008/0301805 A1
(43) Pub. Date: Dec. 4, 2008

(54) METHODS OF COMMUNICATING OBJECT DATA

(75) Inventors: Aavishkar Bharara, Delhi (IN); Judith Morrien, Amersfoort (NL); Paul Hagendoorn, Houten (NL); Vijayanand Tirumalai, Sandy, UT (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/755,886

(22) Filed: May 31, 2007

(51) Int. Cl. G06F 7/04

(52) U.S. Cl. 726/21

(57) ABSTRACT

In an embodiment, a method of communicating an object data is provided. The method comprises receiving the object data from a first medical information system at a second medical information system, checking for an authorization for a user of the second medical information system to view the object data and displaying the object data upon finding the authorization. The method further comprises de identifying the object data upon not finding the authorization for the user and displaying the de identified object data at the second medical information system.

### FIELD OF INVENTION

The invention relates, in general, to methods of protecting privacy of a medical object when an object data comprising health care information of the medical object is shared between various healthcare entities and, in particular, to methods of providing anonymized workflow in a medical facility to ensure privacy of a medical object.

### BACKGROUND OF THE INVENTION

Picture Archiving and Communication Systems (PACS) are used for acquiring, storing and transmitting object data obtained in several medical applications. PACS may be used with several technologies for observing the interior anatomy of a medical object, for example with ultrasound, x-ray, computed tomography (CT), magnetic resonance imaging (MRI) or PET images and the like. The viewing and analysis of the object data on the PACS is normally done by a physician and/or a radiologist, at one of several workstations present at a medical facility such as a hospital, clinic or a laboratory. Typically, the object data comprises an object identification data for the purpose of associating the medical data with the concerned medical object.

The primary limitation in the prior art methods is the inability to provide an anonymized workflow inside the medical facility. For instance, in PACS, a medical staff such as a physician provided with a special privilege can view object data of one or more medical objects in the medical facility without prior permission to view the object data. This contributes to a security concern as the physician is authorized to view the details of the medical objects who are not being treated by the physician or whose details the physician may not be required to know.

In a radiologist workstation inside the medical facility, when a medical staff such as a radiologist sends object data of a medical object to another radiologist for a second opinion, the second radiologist is provided with access to identification details of the medical object. The availability of identification details of the medical object to a third party constitutes an HIPAA issue. Such a scenario is generally observed in privileged and/or important medical objects, as the radiologist dealing with the medical object wants to be doubly sure of the diagnosis. Thus, the prior art radiologist workstations are not enabled to provide controlled access to the object data of the medical objects.

On the other hand, in a diagnostic workstation such as a physician's review workstation in the medical facility, the physician may be interested in obtaining a second opinion on the diagnosis of a medical object by another physician and/or a medical staff. The options available for the physician include the physician sending an offline link of the medical object to a second physician or the physician conducting a conference with the second physician. In the conference facility, the first physician as well as the second physician can view a single web application. During both options, the second physician is revealed of the identification details of the medical object concerned.

In general, prior art PACS machines are configured such that a privileged medical staff by default knows the object data along with the identification details of one or more medical objects, the details of which the privileged medical staff may not be required to know as opposed to the medical objects he is treating and/or the medical objects whose diagnosis is to be reviewed by the privileged medical staff.

Hence there exists a need for providing a method of protecting the privacy of the medical object while sharing the object data concerning the medical object with one or more medical staff inside a healthcare organization, the medical staff not being directly involved in diagnosis and/or treatment of the medical object.

### BRIEF DESCRIPTION OF THE INVENTION

The above-mentioned shortcomings, disadvantages and problems are addressed herein which will be understood by reading and understanding the following specification.

In an embodiment, the invention provides a method of communicating an object data. The method comprises receiving the object data from a first medical information system at a second medical information system, checking for an authorization for a user of the second medical information system to view the object data and displaying the object data upon finding the authorization.

In another embodiment, a method of providing an anonymized workflow is provided. The method comprises sending an object data from a first medical information system to a second medical information system, checking for an authorization for a user of the second medical information system to view the object data, displaying the object data upon finding the authorization for the user, de identifying the object data to obtain a de identified object data upon not finding the authorization for the user, displaying the de identified object data at the second medical information system, receiving the de identified object data from the second medical information system at the first medical information system, re identifying the object data and displaying the object data at the first medical information system.

In yet another embodiment, a computer program product stored in a computer readable media for providing a controlled access to an object data on a medical workstation is provided. The computer program product comprises a routine for receiving a first input via a user interface from a user of the medical workstation to de identify the object data and a routine for de identifying the object data to obtain a de identified object data.

Systems and methods of varying scope are described herein. In addition to the aspects and advantages described in the summary, further aspects and advantages will become apparent by reference to the drawings and with reference to the detailed description that follows.

### BRIEF DESCRIPTION OF THE DRAWINGS

FIG. 1 shows a schematic diagram depicting a medical facility, in an embodiment;

FIG. 2 shows a flow diagram of a method of communicating an object data, in an embodiment;

FIG. 3 shows a flow diagram of a method of checking for an authorization, in an embodiment;

FIG. 4 shows a flow diagram of a method of de identifying an object data, in an embodiment;

FIG. 5 shows a flow diagram of a method of communicating an object data, in another embodiment;

FIG. 6 shows a flow diagram of a method of re identifying an object data, in an embodiment; and

FIG. 7 shows a flow diagram of a method of providing an anonymized workflow, in an embodiment.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

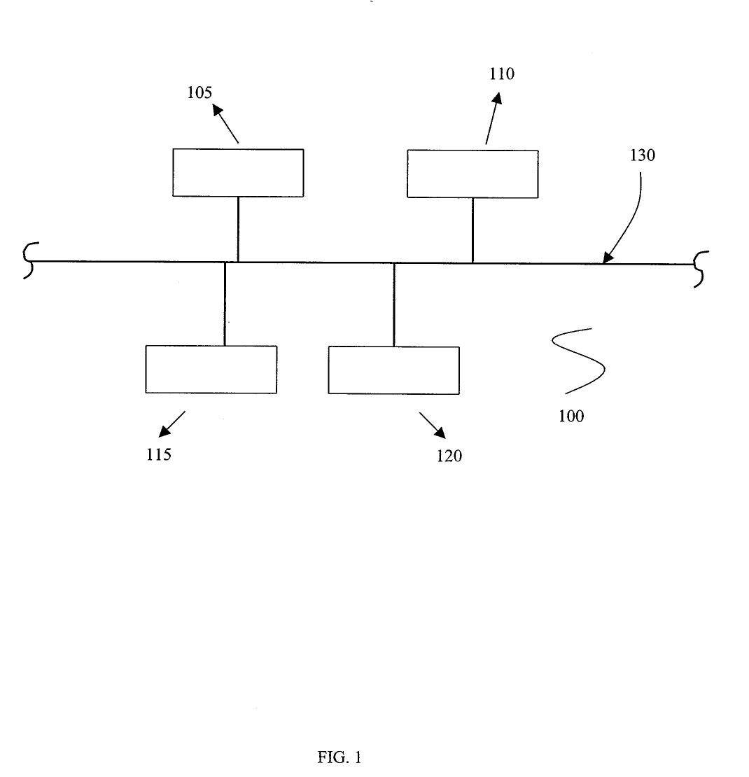

As shown in FIG. 1, a medical facility 100 typically comprises multiple medical information systems 105, 110, 115 and 120 and each medical information system 105, 110, 115 and 120 is configured to communicate in accordance to a communication standard such as a DICOM standard. Although FIG. 1 shows four exemplary medical information systems 105, 110, 115 and 120 it is understood that the number of medical information systems can vary.

The series of medical information systems 105, 110, 115 and 120 can be connected in communication with one another as part of a network 130. An example of the network 130 is a Local Area Network (LAN), such as an Ethernet, installed in a hospital or a medical facility 100. The LAN may also be connected to the Internet or another LAN in another hospital or medical facility via a dedicated line or a public telecommunication line such as ISDN. The network 130 can be interconnected via a hard-wired connection (e.g., cable, bus, etc.) or a wireless connection (e.g., infrared, radio frequency, etc.) or combination thereof.

An embodiment of each of the medical information systems 105, 110, 115 and 120 is one of an imaging system, an image server or a medical workstation. The imaging system is a system operable to record an image related to a medical object as a digital medical data. The imaging system can be one of an X-ray system, a magnetic resonance imaging (MRI) system, a computed tomography (CT) system, an ultra sonography (US) system, a nuclear medicine (NM) system, a digital fluoroscopy (DF) system, a digital radiography (DR) system and a computer radiography (CR) system. The image server generally stores the medical data recorded by the imaging system in a medical database. The exemplary embodiment of the imaging system and the image server are both interfaced in accordance to and/or compatible with the DICOM standard, although other communication standards may be used in other embodiments. Examples of the medical workstations include a diagnostic workstation or a radiologist workstation used by different category of medical staff in a medical facility 100.

Further, examples of the medical information systems 105, 110, 115 and 120 include a hospital information system (HIS), a radiology information system (RIS), a clinical information system (CIS) and a picture archival and communication system (PACS) connected in communication to electronically acquire, store, transmit or manage the medical data.

Each of the medical information systems 105, 110, 115 and 120 comprise a user interface, a network server and a memory unit. Each user interface is generally configured to receive a user input. Examples of the user interface can include monitors, panels, keyboards, mouse, etc. or combinations thereof equipped with elements operable to enable dialogue with a user. Examples of the elements include menus, windows, dialog boxes, control panels, icons, and tool palettes or combination thereof.

The network server is generally configured to handle one or more user requests received from the user interface, including processing the user input and providing the requested information. Examples of the requested medical information can include, but is not limited to, object data concerning a medical object.

The memory unit in each medical information system 105 is generally configured to store the multiple object data acquired and/or received by the other medical information systems 110, 115 and 120 in the network 130. Additionally, the memory unit includes a plurality of program instructions for execution by the network server.

In one embodiment, a method of providing an anonymized workflow in the medical facility 100 by providing controlled access to an object data of a medical object is provided. The controlled access can be provided by selectively de identifying an object data thereby protecting the privacy of the medical object associated with the object data. The medical object refers to an article, an object, a person or an animal. The object data relates to a data concerning the medical object. Typically, the object data comprises a primary object data and a secondary object data. The primary object data is a DICOM compliant object data comprising a medical data and an object identification data. The object identification data includes general information concerning the medical object such as identity, age, height, weight, sex, race and family of the medical object.

The medical data is a data that can be collected over the course of diagnosis and treatments. In general the medical data includes genetic medical data, medical history, physical handicaps, known medical conditions, known medical allergies, and current ailment conditions such as symptoms, duration, temperature, blood pressure, pulse rate, blood test data, urine test data, physician observations and the like. Additionally, the medical data may include drug data such as prescriptions, allergy information, drug interaction information, drug treatment information, overdose information and diagnostic data such as radiology information, laboratory information, clinical information, computed tomography (CT) images, ultra sound images, magnetic resonance images, X-ray images, laboratory test results, doctor progress notes, details about medical procedures, radiological reports, other specialist reports and demographic information.

When using the PACS, it may be desirable for the physician and/or the radiologist to provide a dictation report stating the analysis of the medical data. The dictation report provides useful information and is a handy tool in understanding and/or analyzing the primary object data. The information additional to the primary object data, such as dictation reports or voice annotations can be grouped into a secondary object data.

Typical examples of the secondary object data include but are not limited to a voice clip, an aural annotation, a dictation file and a diagnostic report. The secondary object data may include exam notes and miscellaneous text data such as sticky notes. Further, the secondary object data may comprise the object identification data. The primary object data when combined with the secondary object data constitutes the object data.

The object data may be stored in registers, RAM, ROM, or the like, and may be generated through software, through a data storage structure located in the memory unit such as RAM or ROM, and so forth. The data storage structure comprises a database to store the object data records.

As used herein, the term “confidential identification data” refers to the object identification data that is considered confidential and is desired to be protected. The level of protection associated with the confidential identification data may vary from one application to another. Further, the confidential identification data may be a clinically irrelevant data. For example, name of the medical object is a clinically irrelevant data that can be de identified. Whereas other object identification data such as age and sex of the medical object can be clinically relevant for diagnosing the medical object and hence may not be considered as confidential identification data.

Typically, the confidential identification data includes name of the medical object, birth dates and death dates excluding the year, telephone numbers, fax numbers, electronic mail addresses, social security numbers, medical record numbers, health plan beneficiary numbers, account numbers, certificate/license numbers, vehicle identifiers and serial numbers, device identifiers and serial numbers, web universal resource locators (URLs), Internet Protocol (IP) address numbers, biometric identifiers including finger and voiceprints, full face photographic images and any comparable images. Further, the confidential identification data may include zip codes and treatment-related dates.

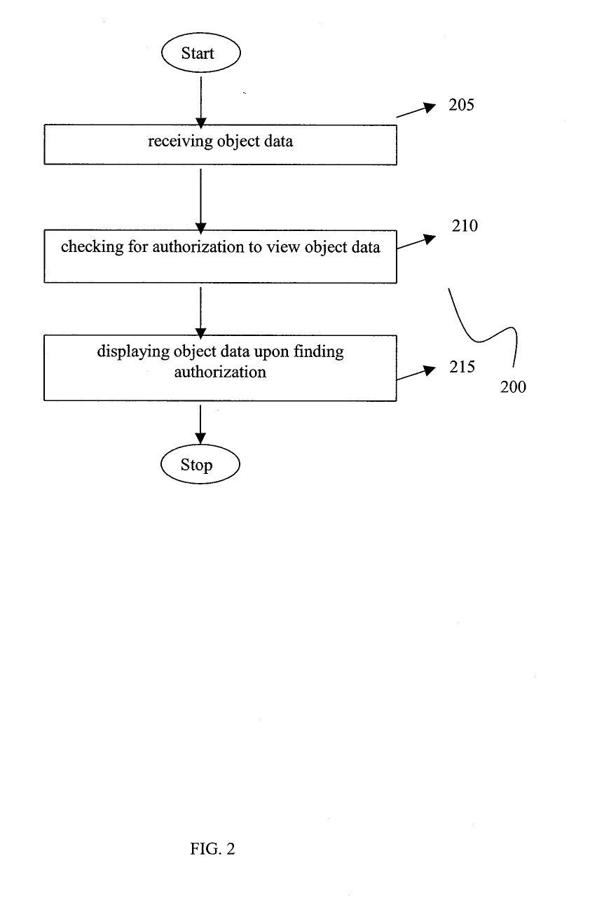

Turning now to FIG. 2, a method 200 of communicating an object data concerning a medical object is provided. The method 200 comprises receiving the object data from a first medical information system 105 at a second medical information system 110 step 205, checking for an authorization for a user of the second medical information system 110 to view the object data step 210 and displaying the object data upon finding the authorization step 215.

The first medical information system 105 and the second medical information system 110 can be configured to communicate via a communication standard such as a DICOM standard. Accordingly, the object data can be classified based on the DICOM compatibility. Generally the primary object data, comprising the medical data and the object identification data, is a DICOM compliant object data and the secondary object data derived from the primary object data may or may not be a DICOM compliant data.

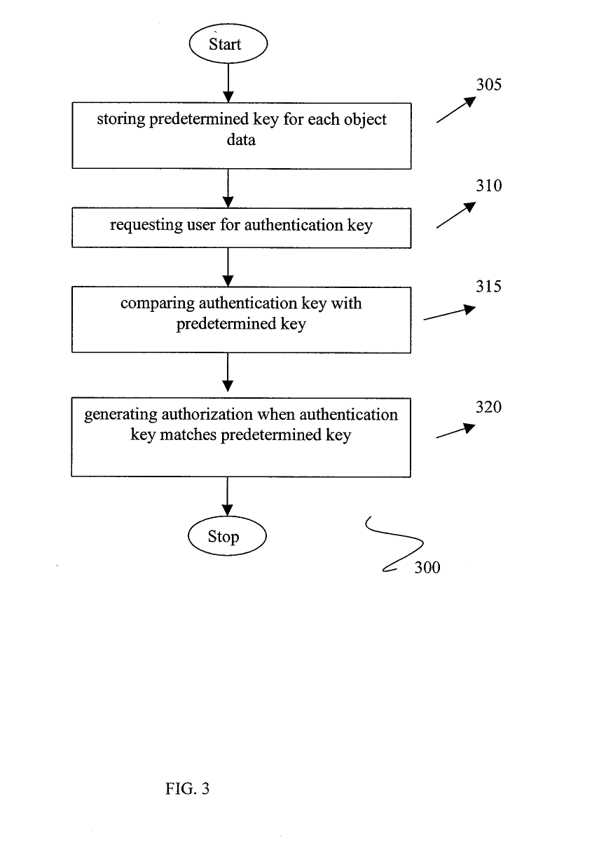

The second medical information system 110 upon receiving the object data from the first medical information system 105 checks for the authorization for the user of the second medical information system 110. The method of checking for authorization is further explained in conjunction with FIG. 3. Each medical information system 105, 110, 115 and 120 in the medical facility 100 is configured to store a predetermined key corresponding to each object data of the medical object step 305. The second medical information system 110 in the process of checking for authorization requests the user for providing an authentication key step 310. The authentication key and the predetermined key may be character strings comprising at least one predetermined character. The predetermined character may include numerical, alphabetic, alphanumeric and other characters and symbols, conventional or arbitrary, as may be desired.

Upon matching the authentication key with the predetermined key step 315 an authorization is generated if the predetermined key matches the authentication key step 320. Upon finding the authorization the second medical information system 110 is configured to display the object data.

Skilled artisans shall however appreciate that other methods of providing authorization such as setting prior permission to view the contents of a file comprising the object data can be used for providing authorization and all such examples are covered in the invention.

In a scenario where the authentication key fails to match the predetermined key thereby failing to generate the authorization, the object data concerning the medical object is de identified. The term “de identified data” as used by HIPAA refers to the object data from which all information that could reasonably be used to identify the medical object has been removed (e.g., removing name, address, social security numbers, etc.).

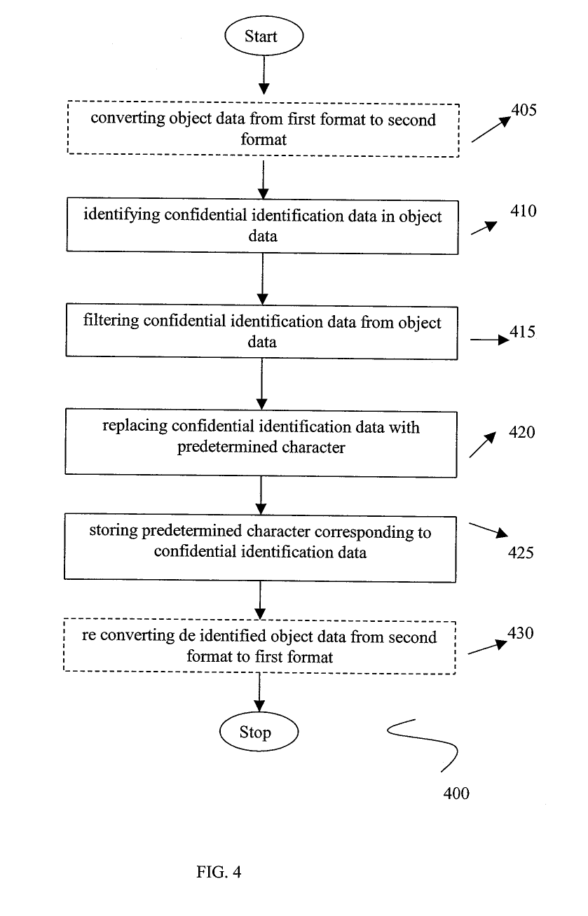

FIG. 4 illustrates a method 400 by which a medical information system 105, 110, 115 and 120 can de identify the object data for purposes of disclosing and/or distributing the de identified object data to one or more third-party entities (e.g., a medical staff) while ensuring privacy of the medical object.

The method 400 as shown in FIG. 4 comprises steps of identifying at least one confidential identification data in the object data step 410, filtering the confidential identification data from the object data step 415 and replacing the confidential identification data with at least one predetermined character step 420.

As shown in FIG. 4, the process of de identifying the object data comprises automatically removing at least one confidential identification data from the object data. The confidential identification data may be one of the primary object data and the secondary object data. The de identification process includes a method for replacing the confidential identification data with at least one predetermined character or a string of predetermined characters that do not comprise relevant medical information about the medical object. It is noted that each of the predetermined character may include numerical, alphabetic, alphanumeric and other characters and symbols, conventional or arbitrary, as may be desired. Further, the predetermined character can be a blank notation, a blank character, a zero frequency wave and a blank wave. Since the predetermined character strings comprise no object identifying information the de identified object data can be made available to a third-party entity without compromising on the privacy of the medical object. The method 400 may further comprise storing the predetermined character or the string of predetermined characters corresponding to the confidential identification data step 425 for further use in are identification process.

In an embodiment, each object data can comprise multiple elements. Each element of the object data can be stored in a predetermined memory location of the data storage structure. The method 400 comprises identifying the confidential identification data based on the predetermined memory location step 410, filtering the confidential identification data from the object data step 415 and replacing the confidential identification data with at least one predetermined character to generate a de identified object data step 420.

Alternatively, the object data may be stored in a myriad of unstructured and structured formats. The method 400 of de identifying may include automatically de identifying structured and/or unstructured object data. The sources that provide structured object data include, for example, financial, laboratory, and pharmacy databases, wherein the object data is typically maintained in database tables. The unstructured object data sources include for example, free-text based documents (e.g., physician reports, etc.), images and waveforms data. Various methods for automatically de identifying the structured and unstructured object data will be discussed in detail below.

The structured object data is typically maintained in database tables, wherein the elements of the object data are known a priori and can readily be searched. In general, the process of de identifying the structured object data comprises identifying confidential identification data based on the prior known elements of the object data and replacing the confidential identification data with at least one predetermined character. Alternatively, multiple DICOM fields comprising the confidential identification data are deleted for de identifying the structured object data.

In an alternative embodiment, the method of de identifying is performed in accordance with the “Safe Harbor” method of the Privacy Rule, in which elements corresponding to the specified attributes in the “Safe Harbor” list are purged from the structured object data.

A next step in the de identification process is to de identify the unstructured object data such as radiology reports. The method includes performing a text string search using any suitable keyword searching application to locate various keywords within the object data to be de identified. For example, all text strings within the object data, such as name of the medical object, physician name, and medical object-specific identification numbers or information, can be located, filtered and possibly be replaced with one or more predetermined characters.

More specifically, in another embodiment, the method of de identifying the object data comprises generating a set of text strings that are to be located in the unstructured object data, based on a list of prior known elements in the structured object data. Thus, the list of prior known elements that are used to identify the confidential identification data in the structured object data can be used to identify confidential identification data in the unstructured object data. The elements of the object data matching the text strings can be categorized as confidential identification data and eliminated from the unstructured object data.

In an exemplary embodiment, the text strings indicating the name of the medical object can be de identified in various manners. For instance, if the name of a medical object is George Bill Antony, then text strings such as “George”, “Antony”, “George Antony”, “George B. Antony”, and “George Bill Antony” can be replaced. Furthermore, de identification of the unstructured object data may include searching for name prefixes such as Dr., Mrs., Mr., Ms., Fr., etc, and de identifying the name that follows.

In an embodiment, the object data can be stored in a particular format such as a voice format, a text format, a waveform format and a frequency format. As shown in FIG. 4, the method 400 of de identifying the object data may further comprise steps of converting the object data from a first format to a second format step 405 and re converting the object data from the second format to the first format step 430. The first format or the second format may be one of a voice format, a text format, a waveform format and a frequency format.

In an exemplary embodiment, the object data is stored in a voice format. The method 400 comprises steps of converting the object data from the voice format to a text format step 405. Many voice to text converting software readily available can be used for converting the object data from the voice format to the text format. The method 400 further comprises steps of identifying the confidential identification data based on the predetermined memory location step 410, filtering the confidential identification data from the object data step 415 and replacing the confidential identification data with a predetermined character such as a blank character to generate a de identified object data step 420. Subsequently, a mapping of the confidential identification data corresponding to the predetermined character can be stored in the memory unit step 425. Upon generating the de identified object data, the de identified object data can be reconverted from the text format to the voice format step 430.

In another exemplary embodiment, the object data can be stored in a waveform format. In one particular scenario, the method 400 may comprise steps of converting the object data from a time domain waveform format to a frequency domain waveform format step 405 using a technique such as a Fourier transformation. The method 400 further comprises steps of identifying at least one confidential identification data in the object data step 410. The object data being present in the frequency domain waveform format, the element of the object data matching a predetermined frequency can be identified as a confidential identification data. The method further comprises steps of filtering the confidential identification data matching the predetermined frequency step 415 and replacing the confidential identification data with at least one predetermined character such as a waveform of a standard frequency step 420. Upon de identifying the object data, the de identified object data is converted from the frequency domain waveform format to the time domain waveform format step 430.

In yet another exemplary embodiment, the object data can be stored in a text format. The method 400 comprises steps of identifying the confidential identification data located at a predetermined memory location step 410, converting the object data from the text format to a waveform format step 405, generating a wave transformation of the confidential identification data, filtering the element of the object data with a waveform substantially similar to the generated wave transformation step 415 and replacing the filtered waveform with a waveform of a standard frequency to generate a de identified object data step 420. Further, the de identified object data can be reconverted to the text format step 430.

The method of de identifying the object data further includes de identifying the secondary object data. In an exemplary embodiment, the medical object is a patient. The secondary object data concerning the medical object may comprise a dictation file stating, “patient X is suffering from disease Y”, where X is the name of the patient. The method 400 de identifies the object data comprising the dictation file. During de identification, the name “X” of the patient is replaced by a blank notation as the name of a patient is identified as a confidential identification data. Therefore, when the de identified object data is transmitted to a second doctor in the medical facility 100, the second doctor hears the de identified dictation clip as “Medical object _ is suffering from disease Y”.

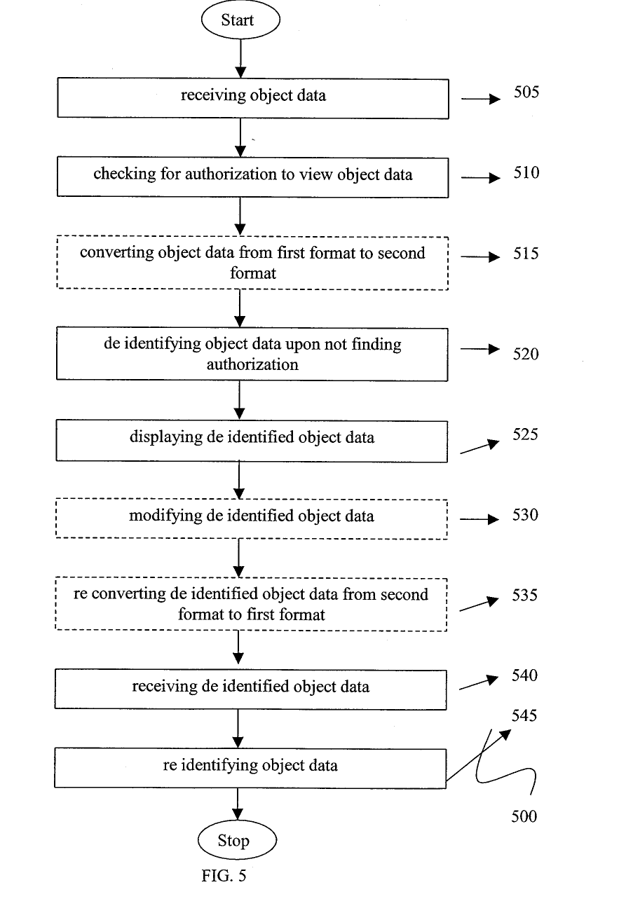

The de identified object data is displayed at the second medical information system 110 following the de identification process, which is further explained in conjunction with FIG. 5.

FIG. 5 shows a method 500 of communicating the object data as described in another embodiment of the invention. The method 500 comprises receiving an object data from the first medical information system 105 at the second medical information system 110 step 505, checking for an authorization to view the object data for a user of the second medical information system 110 step 510, converting the object data from a first format to a second format step 515, de identifying the object data upon not finding the authorization for the user step 520, displaying the de identified object data at the second medical information system 110 step 525, re converting the object data from the second format to the first format step 535, receiving the de identified object data from the second medical information system 110 at the first medical information system 105 step 540 and re identifying the object data at the first medical information system 105 step 545.

The method may further comprise modifying the de identified object data at the second medical information system 110 step 530. The process of modifying may comprise adding, deleting changing or overwriting the contents of the object data by the user of the second medical information system 110. Following the modification, the de identified object data may be sent to the first medical information system 105. Skilled artisans shall however appreciate that the step 530 is described as an optional embodiment and the de identified object data can be sent to the first medical information system 105 devoid of any modification.

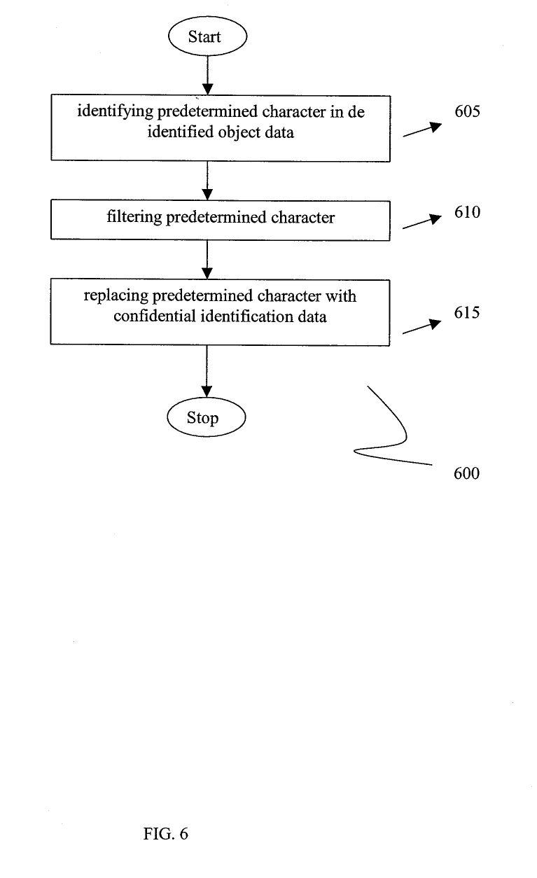

The first medical information system 105 upon receiving the de identified object data is configured to re identify the object data from the de identified object data. The process of re identification of the object data is described in conjunction with FIG. 6. The method 600 of re identifying the object data comprises identifying at least one predetermined character in the de identified object data step 605, filtering the predetermined character from the de identified object data step 610 and replacing the predetermined character with the confidential identification data step 615. In an effort to aid the process of re identification, a mapping between the confidential identification data and the predetermined character, used as a replacement to the confidential identification data, can be sent from the second medical information system 110 to the first medical information system 105 along with the de identified object data. The re identified object data may subsequently be displayed at the first medical information system 105 when desired by the user of the first medical information system 105.

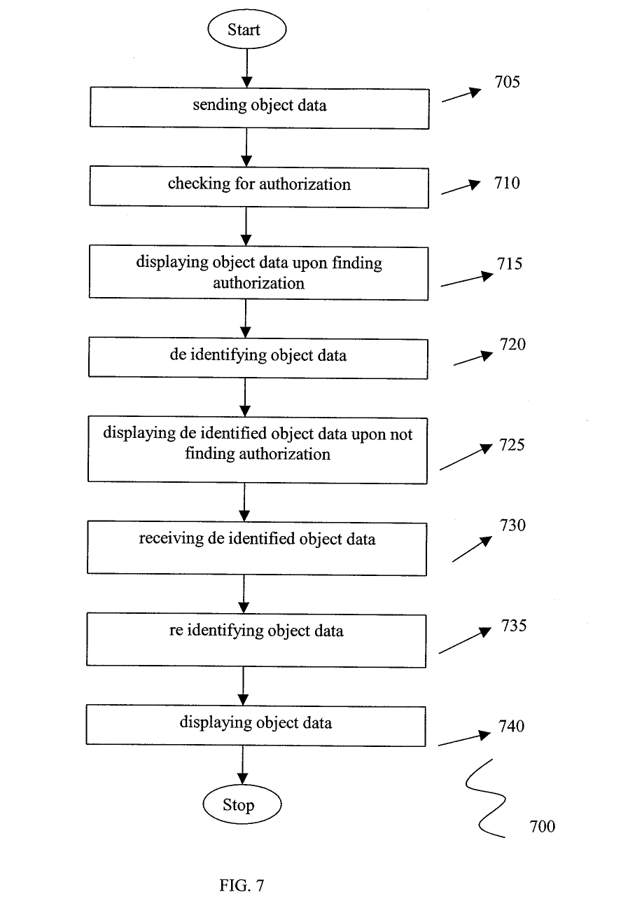

In another embodiment, as shown in FIG. 7, a method 700 of providing an anonymized workflow in a medical facility 100 is provided. The method 700 comprises sending an object data from the first medical information system 105 to the second medical information system 110 step 705, checking for an authorization for a user of the second medical information system 110 to view the object data step 710, displaying the object data upon finding the authorization for the user step 715, de identifying the object data to obtain a de identified object data upon not finding the authorization for the user step 720, displaying the de identified object data at the second medical information system 110 step 725, receiving the de identified object data from the second medical information system 110 at the first medical information system 105 step 730, re identifying the object data step 735 and displaying the object data at the first medical information system 105 step 740. The method 700 may further comprise modifying the de identified object data at the second medical information system 110.

In an exemplary embodiment, a user of the first medical information system 105, a first physician for example sends an object data of a medical object for seeking an opinion of a second physician, a user of the second medical information system 110. Upon receiving the object data the second physician is requested to enter the authentication key. Typically, the authentication key is provided to individuals who are required to know the details of the medical object, such as one or more medical staff directly involved in diagnosing and/or treating the medical object. In a scenario, where the second physician is provided with the authentication key, a matching between the authentication key and the predetermined key results in the generation of authorization for the second physician. Upon finding authorization, the second physician's work list is updated to include the object data of the medical object. Subsequently, the object data along with the confidential identification data is presented to the second physician who is authorized to view the object data.

As an alternative embodiment, in a scenario where the second physician is not provided with the authentication key, the authentication key fails to match the predetermined key, following which the object data is de identified. The de identified object data, masking the clinically irrelevant as well as the confidential identification data successfully protects identity of the medical object from the second physician. Subsequently, the second physician's work list is updated to include the de identified object data of the medical object.

Further, upon viewing the de identified object data the second physician may modify the de identified object data to include his comments and/or opinion. The modified de identified object data can be sent to the first physician for reference. The object data can be re identified from the modified de identified object data by using the method 600. Following the re identification process the object data can be displayed at the first medical information system 105.

In yet another embodiment, a computer program product stored in a computer readable media for providing a controlled access to an object data in a medical workstation is provided. The computer program product comprises a routine for receiving a first input via a user interface from a user of the medical workstation to de identify the object data and a routine for de identifying the object data to obtain a de identified object data. The method may further comprise a routine for receiving a second input via the user interface from the user of the medical workstation to re identify the object data and a routine for re identifying the object data.

The routine for de identifying the object data comprises a routine for identifying at least one confidential identification data in the object data, a routine for filtering the confidential identification data from the object data and a routine for replacing the confidential identification data with at least one predetermined character.

The computer program product may further comprise a routine for storing the predetermined character corresponding to the confidential identification data.

The routine for re identifying the object data comprises a routine for identifying at least one predetermined character in the de identified object data, a routine for filtering the predetermined character from the de identified object data and a routine for replacing the predetermined character with the confidential identification data.

In one embodiment, the computer program product may further comprise a routine for converting the object data from a first format to a second format and a routine for re converting the object data from the second format to the first format, the first format and the second format comprising one of a voice format, a text format, a waveform format and a frequency format.

The computer program product provides the user of a diagnostic workstation with an option to de identify the object data via a user interface. The de identification option can be provided as a menu item in the user interface. In an exemplary embodiment, the object data may be displayed in a web application and selecting the menu item may result in de identifying the object data displayed. The user of the medical workstation may subsequently send an offline link or identification number of the object data via a mail to another medical staff or may share the de identified object data in a conference session with another medical staff. In both the above-mentioned scenarios the identity of the medical object is protected from the medical staff.

The computer program product can be a tangible record in one or more of a printed document, a computer floppy disk, a computer CD-ROM disk, or any other desired medium. The computer program product can be stored in a computer readable medium, such as a floppy disk or a CD-ROM disk, the medium and other computer readable files.

In general, various embodiments as described herein include methods for protecting privacy of a medical object when an object data concerning the medical object is shared between various medical information systems 105, 110, 115 and 120 within a medical facility 100. The above-description of the embodiments of the methods 200, 500 and 700, and the computer program product have the technical effect of providing an anonymized workflow that helps in protecting the privacy of a medical object, while sharing the object data concerning the medical object among one or more medical information systems 105, 110, 115 and 120 within a health care organization.

It is to be understood that the embodiments described herein may be implemented in various forms of hardware, software, firmware, special purpose processors, or combinations thereof. In one exemplary embodiment, methods 200, 300, 400, 500, 600 and 700 described herein are implemented in software as an application comprising program instructions that are tangibly embodied on one or more program storage devices (e.g., hard disk, magnetic floppy disk, RAM, CD Rom, DVD, ROM and flash memory), and executable by any device or machine comprising suitable architecture. It is to be further understood that because the constituent method steps depicted in the accompanying Figures can be implemented in software, the actual flow of the process steps may differ depending upon the manner in which the application is programmed. Given the teachings herein, one of ordinary skill in the related art will be able to contemplate these and similar implementations or configurations of the invention.

The method may be readily implemented in the form of computer software instructions executed by a system in a medical facility 100. The system may be a computer, an imaging modality such as an ultrasound system, a computed tomography system, a magnetic resonance imaging system and an X ray system, a medical information system such as a laboratory information system (LIS), a clinical information system (CIS), a radiology information system (RIS) and a picture archival and communication system (PACS), an imaging server and the like.

Some of the advantages of the invention, described in various embodiments are listed below.

The method described herein provides an anonymized workflow in a medical facility by protecting identity of a medical object. The de identified object data concerning the medical object is devoid of confidential identification data, yet comprises identification data, which are clinically relevant, thereby providing optimized information to a medical staff to provide an unbiased opinion.

The method provides a controlled access to the object data of a medical object thereby enabling only authorized individuals to view the object data concerning the medical object.

The computer program product provided in one embodiment provides a single click anonymized facility at a medical workstation.

Additionally, the invention provides a method for de identifying secondary object data such as voice clips, aural annotations and dictation files. De identifying the secondary object data provides a complete protection to the privacy of the medical object. Hence the object data comprising the secondary object data can be used for various medical applications.

In various embodiments, methods for providing an anonymized workflow in a medical facility are described. However, the embodiments are not limited and may be implemented in connection with different applications. The application of the invention can be extended to other areas, for example a workflow involving, sharing any type of protected or private information, while maintaining individual privacy. For instance, the method as described herein can be used for enabling schools or colleges or educational agencies, for example, to share student records for any desired application, to enable sharing of employer or employee records, performance appraisals, etc. The invention provides a broad concept of providing controlled access to a data which can be adapted in a medical institution, such as a hospital, clinic, research facility, university, pharmaceutical company, governmental organization and the like. Accordingly, the invention is not limited to a hospital setting. The design can be carried further and implemented in various forms and specifications.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of communicating an object data, the method comprising:
receiving the object data from a first medical information system at a second medical information system;
checking for an authorization for a user of the second medical information system to view the object data; and
displaying the object data upon finding the authorization.

2. The method of claim 1, further comprising:
de identifying the object data to obtain a de identified object data upon not finding the authorization for the user; and
displaying the de identified object data at the second medical information system.

3. The method of claim 2, further comprising modifying the de identified object data at the second medical information system.

4. The method of claim 2, wherein de identifying the object data comprises:
identifying at least one confidential identification data in the object data, the confidential identification data being data for identifying a medical object;
filtering the confidential identification data from the object data; and
replacing the confidential identification data with at least one predetermined character.

5. The method of claim 4, further comprising storing the predetermined character corresponding to the confidential identification data.

6. The method of claim 1, further comprising storing a predetermined key for each object data corresponding to a medical object.

7. The method of claim 6, wherein the method of checking comprises:
requesting the user for an authentication key;
comparing the authentication key with the predetermined key; and
generating the authorization when the authentication key matches the predetermined key.

8. The method of claim 7, wherein the authentication key and the predetermined key are character strings comprising at least one predetermined character.

9. The method of claim 2, further comprising:
receiving the de identified object data from the second medical information system at the first medical information system; and
re identifying the object data.

10. The method of claim 9, wherein re identifying the object data comprises:
identifying at least one predetermined character in the de identified object data;
filtering the predetermined character from the de identified object data; and
replacing the predetermined character with the confidential identification data.

11. The method of claim 1, wherein the first medical information system comprises one of a radiology information system (RIS) and a picture archival and communication system (PACS).

12. The method of claim 1, wherein the second medical information system comprises one of a radiology information system (RIS) and a picture archival and communication system (PACS).

13. The method of claim 1, wherein the first medical information system and the second medical information system are connected via a network.

14. The method of claim 1, wherein the first medical information system and the second medical information system communicate via a DICOM standard communication.

15. The method of claim 1, further comprising:
converting the object data from a first format to a second format; and
reconverting the object data from the second format to the first format.

16. The method of claim 15, wherein the first format is one of a voice format, a text format, a waveform format and a frequency format.

17. The method of claim 15, wherein the second format is one of a voice format, a text format, a waveform format and a frequency format.

18. A method of providing an anonymized workflow, the method comprising:
sending an object data from a first medical information system to a second medical information system;
checking for an authorization for a user of the second medical information system to view the object data;
displaying the object data upon finding the authorization for the user;
de identifying the object data to obtain a de identified object data upon not finding the authorization for the user;
displaying the de identified object data at the second medical information system;
receiving the de identified object data from the second medical information system at the first medical information system;
re identifying the object data; and
displaying the object data at the first medical information system.

19. The method of claim 18, further comprising modifying the de identified object data at the second medical information system.

20. A computer program product stored in a computer readable media for providing a controlled access to an object data on a medical workstation, the computer program product comprising:
a routine for receiving a first input via a user interface from a user of the medical workstation to de identify the object data; and
a routine for de identifying the object data to obtain a de identified object data.

21. The computer program product of claim 20, further comprising:
a routine for receiving a second input via the user interface from the user of the medical workstation to re identify the object data; and
a routine for re identifying the object data.

22. The computer program product of claim 20, wherein the routine for de identifying the object data comprises:
a routine for identifying at least one confidential identification data in the object data, the confidential identification data being data for identifying a medical object;
a routine for filtering the confidential identification data from the object data; and
a routine for replacing the confidential identification data with at least one predetermined character.

23. The computer program product of claim 22, further comprising a routine for storing the predetermined character corresponding to the confidential identification data.

24. The computer program product of claim 21, wherein the routine for re identifying the object data comprises:
a routine for identifying at least one predetermined character in the de identified object data;
a routine for filtering the predetermined character from the de identified object data; and
a routine for replacing the predetermined character with the confidential identification data.

25. The computer program product of claim 20, further comprising:
a routine for converting the object data from a first format to a second format; and
a routine for reconverting the object data from the second format to the first format.

26. The computer program product of claim 25, wherein the first format is one of a voice format, a text format, a waveform format and a frequency format.

27. The computer program product of claim 25, wherein the second format is one of a voice format, a text format, a waveform format and a frequency format.
